(19) United States
(12) Patent Application Publication
(10) Pub. No.: US 2025/0333082 A1
(43) Pub. Date: Oct. 30, 2025

(54) COMPUTER-IMPLEMENTED METHOD FOR EVALUATING THE ACCURACY OF A SWARM TRAJECTORY POSITION

(71) Applicant: Continental Automotive Technologies GmbH, Hannover (DE)

(72) Inventors: Dominik Senninger, Burglengenfeld (DE); Danilo Gasdzik, Barbing (DE)

(73) Assignee: Continental Automotive Technologies GmbH, Hannover (DE)

(21) Appl. No.: 18/552,212

(22) PCT Filed: Mar. 18, 2022
(86) PCT No.: PCT/DE2022/200049

§ 371 Date: Mar. 28, 2024

(30) Foreign Application Priority Data
Mar. 26, 2021 (DE) 10 2021 203 080.7

(51) Int. Cl. B60W 60/00; G01C 21/00; G01C 21/34

(52) U.S. Cl. CPC B60W 60/0027; G01C 21/3407; G01C 21/3804

(57) ABSTRACT

The invention relates to a computer-implemented method for assessing the accuracy of a swarm trajectory position (xᵢ, yᵢ), defined by a processing device (18), of a swarm trajectory (xᵢ, yᵢ) on a defined road section (10), wherein a multiplicity of ego trajectory positions (xₙ, yₙ) are captured and swarm trajectory positions (xᵢ, yᵢ) are generated therefrom, wherein a standard deviation (σᵢ) is formed for each formed swarm trajectory value (xᵢ) of the swarm trajectory (xᵢ, yᵢ) and the generated swarm trajectory positions (xᵢ, yᵢ) and a respectively associated accuracy coefficient (K_{G}) are then stored as a pair for each swarm trajectory position (xᵢ, yᵢ), wherein the accuracy coefficients (K_{G}) are proportional to the standard deviations (σᵢ). The invention furthermore relates to a computer-implemented method for controlling a trailing vehicle (12), to a computer-implemented method for determining a position of a trailing vehicle (26) on the defined road section (10), to a control system for controlling the trailing vehicle (26), and to a computer program product, which use the method for assessing accuracy.

The invention relates to a computer-implemented method for assessing the accuracy of a swarm trajectory position, defined by a processing device, of a swarm trajectory on a defined road section, to a computer-implemented method for controlling a trailing vehicle on a defined road section, in which the method for assessing accuracy is used, to a control system for controlling a trailing vehicle, and to a computer program product that is designed to carry out said methods.

There are various GNSS (Global Navigation Satellite System) receivers available on the market that are able to ascertain their own positions. Some of these receivers also provide, in addition to the desired position, information about the accuracy of the position, with this value often being inaccurate. There is also the problem that different manufacturers of these receivers often use different methods to compute the accuracy, and these are therefore not comparable.

If for example an algorithm for ascertaining a position of a vehicle on a defined road section, in addition to the received position, also uses inaccurate values for the accuracy of this position, for example to weight data, then this leads to inaccurate or even incorrect results.

The object of the invention is therefore to propose a method by way of which it is possible to provide values of an accuracy in relation to a position in a more reliable manner.

This object is achieved by way of a computer-implemented method having the combination of features in claim 1.

A computer-implemented method for controlling a trailing vehicle on a defined road section, a control system for controlling a trailing vehicle so as to drive a road section, and a computer program that is able to carry out the methods, are the subject matter of the other independent claims.

Advantageous embodiments of the invention are the subject matter of the dependent claims.

A computer-implemented method for assessing the accuracy of a swarm trajectory position, defined by a processing device, of a swarm trajectory on a defined road section has the following steps:
capturing a multiplicity of ego trajectory positions of ego vehicles moving on the defined road section;
generating a swarm trajectory having a multiplicity of swarm trajectory positions, wherein, at predefined swarm trajectory values y_{i,def}, the associated swarm trajectory values xᵢ are formed from the multiplicity of ego trajectory values xₙ;
forming a standard deviation oi for each formed swarm trajectory value xᵢ of the swarm trajectory;
storing pairs of the generated swarm trajectory positions and an associated accuracy coefficient for each swarm trajectory position, wherein the accuracy coefficients are proportional to the standard deviations σᵢ formed for each swarm trajectory position.

Swarm trajectories are essentially motion trajectories that are formed from a fusion of a multiplicity of individual trajectories, wherein each individual trajectory is assigned to an individual vehicle moving on the defined road section. These individual trajectories are therefore also referred to as ego trajectories and are associated with the individual vehicles, which are also referred to as ego vehicles.

According to the method, the swarm trajectory is accordingly created from the ego trajectories of the ego vehicles moving on the defined road section, and thus from their GNSS data. The swarm trajectory is essentially formed from a multiplicity of swarm trajectory positions or points (xᵢ, yᵢ). For each of these points (xᵢ, yᵢ), the points of intersection of the individual trajectories that contributed to the creation of the swarm trajectory at this respective position (xᵢ, yᵢ) are then computed perpendicular to the direction of travel of the respective ego vehicle. In other words, predefined swarm trajectory values y_{i,def} are used to form the standard deviation σᵢ from the swarm trajectory values xᵢ that are associated with the predefined swarm trajectory value y_{i,def} at these points in the direction of travel. The standard deviation σᵢ is essentially a measure of the scatter of these values Xₘ around the value xᵢ of the swarm trajectory under consideration. This standard deviation σᵢ may be considered to be a measure of the accuracy that is normally able to be achieved by GNSS receivers at this swarm trajectory position (xᵢ, yᵢ) under consideration.

After a measure of the accuracy in the form of the standard deviation σᵢ has been determined, the respective swarm trajectory position (xᵢ, yᵢ) under consideration may then be stored together with an accuracy coefficient. The accuracy coefficient may in this case be the standard deviation σᵢ itself, but it is also possible to store a representative factor for the standard deviation σᵢ as an accuracy coefficient. If the standard deviation σᵢ is not stored directly as an accuracy coefficient, but rather a factor representing the standard deviation σᵢ, this should be considered to be proportional to the determined standard deviation σᵢ. “Proportional” should be understood here to mean not only the mathematical ratio via a constant factor; proportional may also mean, in the context of the method described above, that the standard deviation values σᵢ are combined into groups in order to directly assess the accuracy of a position, for example “high accuracy”, “medium accuracy”, “low accuracy” groups.

The pairs of the generated swarm trajectory position and the corresponding accuracy coefficient are stored together, wherein stored should also be understood to mean entered into a map that is made available to a trailing vehicle. The trailing vehicle is in this case a vehicle that trails, in time, all ego vehicles from whose ego trajectories the swarm trajectory was formed.

The trailing vehicle may accordingly have access to a map formed in this way, but the map may also be accessed for example by other services, which are used for example to consolidate traffic signs present on the defined road section.

The described method therefore offers the possibility of determining positions or even entire areas with good or poor GNSS accuracy. These accuracies may then be used in other algorithms to be able to estimate the accuracy or a weighting.

In one advantageous embodiment of the method described above, sensors of the individual ego vehicles moving on the defined road section capture the multiplicity of ego trajectory positions and transmit the multiplicity of ego trajectory positions to a processing device arranged outside the ego vehicles, in response to which the processing device then generates the swarm trajectory.

In this advantageous embodiment, the raw data are thus essentially transmitted to the processing device, such that this generates the swarm trajectory having a multiplicity of swarm trajectory positions by performing multiple computing steps.

In one alternative embodiment, however, it is also possible for the sensors of the individual ego vehicles moving on the defined road section to capture the multiplicity of ego trajectory positions and then for each ego vehicle to generate its ego trajectory from its captured ego trajectory positions. Only then does each ego vehicle transmit its generated ego trajectory to a processing device arranged outside the ego vehicles, wherein the processing device then generates the swarm trajectory from these ego trajectories. In this advantageous alternative embodiment, parts of the computing method for generating the swarm trajectory are thus performed in the ego vehicles themselves.

A computer-implemented method for controlling a trailing vehicle on a defined road section has the following steps:
creating a map of the defined road section containing pairs of swarm trajectory positions and associated accuracy coefficients for each swarm trajectory position, as has been described in the above method;
controlling a trailing vehicle so as to drive the road section based on the created map.

GNSS receivers in such trailing vehicles do not estimate their accuracy correctly in all situations, but these situations are usually locally reproducible. The above-described created map now contains information about the accuracy of received swarm trajectory positions, and thus information about locations where GNSS receivers often estimate their accuracy to be too good. If this information is then available to the trailing vehicle from the map, the trailing vehicle may be controlled more accurately than has been usual up to now on the basis of this created map.

Preferably, the trailing vehicle is in this case controlled using a controller of an at least partially autonomous vehicle system. In particular in partially autonomous or even autonomous driving, it is important to know the reliability of the position data processed to control the trailing vehicle, in order thus to enable highly accurate control of a driverless trailing vehicle.

As an alternative, however, it is also possible for a trailing vehicle to be controlled by a driver, but for an output unit of a driver assistance system to be present, which output unit outputs control specifications for controlling the trailing vehicle based on the created map. One implementation of such a system could for example be a navigation system.

A computer-implemented method for determining a position of a trailing vehicle on a defined road section has the following steps:
performing an above-described method for assessing the accuracy of a swarm trajectory position defined by a processing device;
receiving, from at least two different sources, respective pairs of a potential position of the trailing vehicle on the defined road section and a source-specific accuracy coefficient associated with the potential position, wherein a first potential position is a swarm trajectory position, and wherein a first accuracy coefficient is proportional to the standard deviation σᵢ formed for the swarm trajectory position, wherein the swarm trajectory position and the first accuracy coefficient were generated in accordance with the method as claimed in claim 1;
weighting each of the received potential positions based on the associated, source-specific accuracy coefficients;
determining the position of the trailing vehicle by fusing the weighted potential positions.

In order to determine a position of a trailing vehicle on a defined road section that is as realistic as possible, data from two different sources are accordingly used. The first source is in this case the memory that has stored the swarm trajectory position as described above together with the associated accuracy coefficient. The second source may be a sensor that likewise determines a potential position and in the process outputs an associated accuracy coefficient. Based on these source-specific accuracy coefficients for these potential positions, it is then possible to weight the received potential positions and to determine the position of the trailing vehicle from these weighted potential positions.

The technical advantage in the trailing vehicle is thus that the algorithms, which determine the position of the trailing vehicle from the values of one or more sensors, then receive a further source for estimating the accuracy of GNSS data. Knowing the accuracy of the respective sensors is important, since weighting takes place when the sensor data are fused. In this case, sensors that have a higher accuracy are weighted to a greater extent. If the information that the swarm trajectory position should be assessed as having high accuracy is then available to the trailing vehicle, this information may be weighted higher than for example the potential positions that have been delivered by the other sensors. Conversely, if the GNSS position is less accurate, it is however also possible for the other sensors to be weighted higher. On the whole, therefore, improved positioning of the trailing vehicle is possible.

The described method therefore makes it possible to be able to correct the problems of the error-prone accuracy estimate of commercially available GNSS receivers.

The trailing vehicle may accordingly also process information from multiple sensors. It is possible in this case for a pair of a second potential position and a source-specific accuracy coefficient associated with the second potential position to be determined using a sensor assigned to the trailing vehicle. In other words, such a sensor is arranged in the trailing vehicle itself, for example a camera.

As an alternative or in addition, it is however also possible for the second potential position and the associated source-specific accuracy coefficient to be determined using a sensor of an infrastructure in the region of the defined road section. In other words, there may also be sensors outside the trailing vehicle that are arranged at, on or around the defined road section and are capable of capturing the second potential position of the trailing vehicle.

In a computer-implemented method for controlling a trailing vehicle on a defined road section, a position of the trailing vehicle on the defined road section is first determined in this case, as described above, and then the trailing vehicle is controlled so as to drive the road section based on this determined position.

It is possible in this case for the trailing vehicle to be controlled using a controller of an at least partially autonomous vehicle system. However, as an alternative, it is also possible for an output unit of a driver assistance system to output control specifications for controlling the trailing vehicle.

A control system for controlling a trailing vehicle so as to drive a road section has a processing device that is designed to perform the method for assessing the accuracy of a swarm trajectory position, defined by a processing device, of a swarm trajectory on a defined road section. The control system furthermore has a controller that is designed to control the trailing vehicle.

A further control system for controlling a trailing vehicle so as to drive a road section has a processing device that is designed to perform the method for determining a position of a trailing vehicle on the defined road section as described above, and furthermore has a controller for controlling the trailing vehicle.

An advantageous computer program product is designed to carry out the method for assessing the accuracy of the swarm trajectory position, defined by a processing device, of a swarm trajectory on a defined road section and/or the method for determining a position of a trailing vehicle on a defined road section.

Advantageous embodiments of the invention are explained in more detail below with reference to the appended drawings. In the figures:

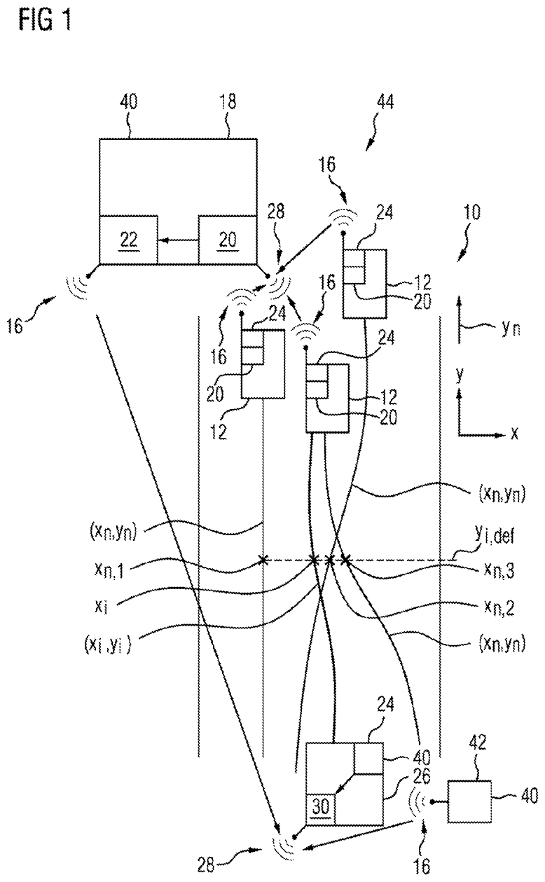

FIG. 1 shows a schematic plan view from above of a defined road section containing multiple ego vehicles moving along ego trajectories, a swarm trajectory formed from the ego trajectories, and a trailing vehicle moving along the swarm trajectory.

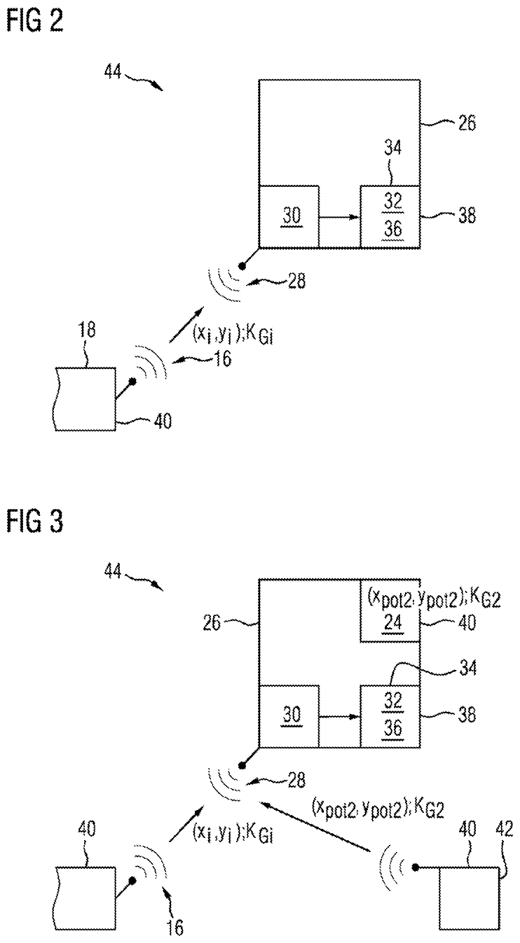

FIG. 2 shows a schematic detailed illustration of a first advantageous example of the trailing vehicle from FIG. 1;

FIG. 3 shows a schematic illustration of a second advantageous example of the trailing vehicle from FIG. 1;

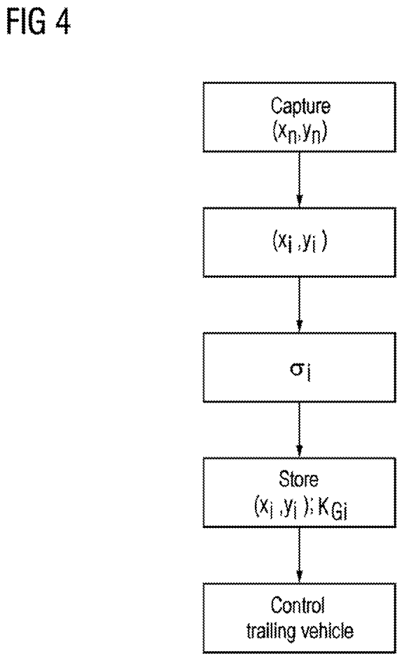

FIG. 4 shows a schematic flowchart illustrating steps of a method for assessing the accuracy of a swarm trajectory position, defined by a processing device, of the swarm trajectory on the defined road section from FIG. 1; and

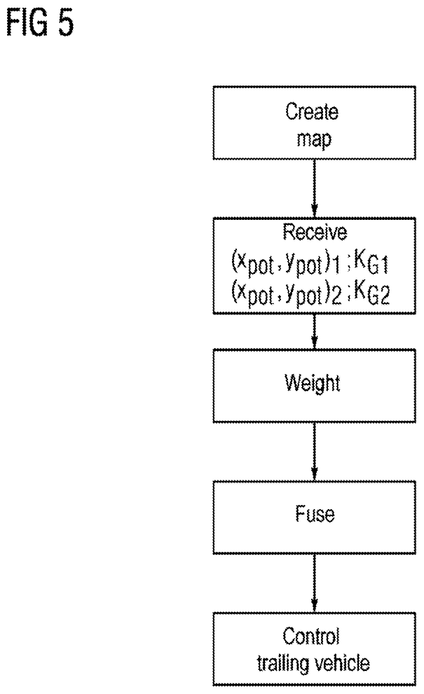

FIG. 5 shows a schematic flowchart illustrating steps of a method for determining the position of the trailing vehicle on the defined road section from FIG. 1.

FIG. 1 shows a schematic plan view from above of a defined road section 10 on which multiple ego vehicles 12 are moving along ego trajectories (xₙ, yₙ) associated therewith. Each ego trajectory (xₙ, yₙ) is formed in this case from an infinite number of ego trajectory points, which are composed two-dimensionally from the values xₙ and yₙ, wherein yₙ are values that represent the direction of travel of the respective ego vehicle 12. The values xₙ are arranged, relative to the values yₙ, on the perpendicular x-axis thereto (see Cartesian coordinate system at the edge).

A swarm trajectory (xᵢ, yᵢ) is formed from a multiplicity of such ego trajectories (xₙ, yₙ) by fusing the ego trajectories (xₙ, yₙ). This also results, for the swarm trajectory (xᵢ, yᵢ), in a multiplicity of swarm trajectory points or swarm trajectory positions (xᵢ, yᵢ). To form the swarm trajectory (xᵢ, yᵢ), for the sake of simplicity, the x-values of the ego trajectories (xₙ, yₙ), in the example in FIG. 1 x_{n,1} of the first ego trajectory, x_{n,2} of the second ego trajectory and x_{n,3} of the third ego trajectory, are averaged to form an x-value xᵢ of the swarm trajectory (xᵢ, yᵢ) at predefined value positions in the direction of travel yₙ of the ego trajectories (xₙ, yₙ), these being denoted y_{1,def} in FIG. 1. Multiple x-values of different ego trajectories (xₙ, yₙ) are accordingly used, such that it is possible to form a standard deviation σᵢ for the formed swarm trajectory value xᵢ of the swarm trajectory (xᵢ, yᵢ) from the plurality of x-values.

In a first example shown in FIG. 1, in order to form the swarm trajectory (xᵢ, yᵢ) and the associated standard deviations σᵢ as described above, the ego vehicles 12 send their ego trajectory positions (xₙ, yₙ) to a processing device 18 via corresponding transmitters 16. This processing device 18 receives the ego trajectory positions (xₙ, yₙ) and uses this information to determine the swarm trajectory (xᵢ, yᵢ) and the respectively associated standard deviation σᵢ in a processing module 20. Depending on the implementation, the standard deviation σᵢ is treated directly as an accuracy coefficient K_{G}, which indicates the accuracy of the determined swarm trajectory positions (xᵢ, yᵢ). As an alternative, however, it is also possible to convert the determined standard deviations σᵢ to a representative accuracy coefficient K_{G}, which is proportional to the standard deviations σᵢ. Proportional in this case means not only a pure mathematical proportionality with a constant factor for the conversion; it is also possible for groups of standard deviations σᵢ to be combined to form assessment criteria, and for these then to be treated as an accuracy coefficient K_{G}. By way of example, such groups may be “high accuracy”, “medium accuracy”, “low accuracy”.

The processing device 18 then stores the pairs of the generated swarm trajectory positions (xᵢ, yᵢ) and the respectively associated accuracy coefficients K_{G} in a storage apparatus 22. It is possible in this case for these pairs to be stored in the form of a map, in which the accuracy coefficient K_{G} is then also plotted for each generated swarm trajectory position (xᵢ, yᵢ).

To capture the ego trajectory positions (xₙ, yₙ), the ego vehicles 12 have sensors 24, as illustrated in FIG. 1. These sensors 24 may for example be cameras, but it is also possible for the ego vehicles 12 to receive GPS data from a backend, such that the sensors 24, in this case, are formed by a corresponding GPS receiver.

As an alternative to the possibility of all computing steps being performed in the processing device 18, it is also possible for the ego vehicles 12, in addition to their sensors 24, to have their own processing modules 20, wherein the respective ego trajectory (xₙ, yₙ) is formed in these ego processing modules 20 from the ego trajectory positions (xₙ, yₙ) of the respective ego vehicle 12. The ego trajectories (xₙ, yₙ) thus generated are then transmitted directly to the processing device 18 in order to determine therein the swarm trajectory (xᵢ, yᵢ) and the associated standard deviation σᵢ.

If the processing device 18 in the processing module 20 has then ascertained the swarm trajectory (xᵢ, yᵢ) and the associated standard deviation σᵢ or the associated accuracy coefficient K_{G} and stored them in the storage apparatus 22, for example in the form of a map, it is possible to send this information, for example the stored map, to a trailing vehicle 26, which trails the ego vehicles 12 in time on the defined road section 10. The trailing vehicle 26 receives the formed swarm trajectory (xᵢ, yᵢ) and the associated accuracy coefficients K_{G} via a receiver 28 and is then controlled by a controller 30 based on the received map.

The controller 30 may in this case be part of an at least partially autonomous vehicle system 32, in which the ego vehicle 12 is controlled partially autonomously or fully autonomously via a control unit 34, or the controller 30 communicates with an output unit 36 of a driver assistance system 38, which outputs control specifications to a driver of the trailing vehicle 26, for example via a navigation system display.

FIG. 2 shows the trailing vehicle 26 in a schematic detailed illustration of a first advantageous example of the trailing vehicle 26.

FIG. 3 shows a schematic detailed illustration of a second advantageous example of the trailing vehicle 26 from FIG. 1, in which the controller 30 is designed to determine a position of the trailing vehicle 26 on the defined road section 10. To this end, the controller 30 not only uses, as already described above, the swarm trajectory (xᵢ, yᵢ) received from the processing device 18 and its associated accuracy coefficient K_{G,i}, but also uses data from a second source 40, which data are linked to the position of the trailing vehicle 26. The controller 30 accordingly receives a respective potential position (xₚₒₜ, yₚₒₜ) of the trailing vehicle 26 from at least two different sources 40, weights these potential positions (xₚₒₜ, yₚₒₜ) based on their associated accuracy coefficients K_{G}, and then determines the position of the trailing vehicle 26 through fusion. As illustrated in FIG. 3, the second source 40 may for example be a sensor 24 of the trailing vehicle 26, such as for example a camera, but it is also possible for the received information that is processed to originate from a sensor 24 that is assigned to an infrastructure 42 that is arranged in the region of the defined road section 10. This may likewise for example be a camera that is set up or fixedly installed in the region of the road section 10.

Based on the position of the trailing vehicle 26 that is thus determined, the controller 30 may then control the trailing vehicle 26 as in the first example described with reference to FIG. 2.

On the whole, a description is thus given, with reference to FIG. 1 to 3, of a control system 44 by way of which, using the processing device 18 and the controller 30, the trailing vehicle 26 is able to be controlled in a more reliable manner than known up to now.

With regard to this control, FIG. 4 shows a schematic flowchart that assesses steps of a method for assessing the accuracy of a swarm trajectory position (xᵢ, yᵢ) defined by the processing device 18. In this case, in a first step, a multiplicity of ego trajectories (xₙ, yₙ) are captured by a multiplicity of ego vehicles 12. In the next step, the swarm trajectory (xᵢ, yᵢ) is then formed from these ego trajectories (xₙ, yₙ). In the following step, the standard deviation of is formed for each formed swarm trajectory value xᵢ of the swarm trajectory (xᵢ, yᵢ).

In a further step, pairs are then stored, which pairs are composed of the generated swarm trajectory position (xᵢ, yᵢ) and an associated accuracy coefficient K_{G,i}, wherein the storage may for example take place in a map. In a final step, a trailing vehicle 26 is then controlled on the basis of the map data.

With reference to a positioning of the trailing vehicle 26 on the defined road section 10, FIG. 5 shows a schematic flowchart containing steps of a method for determining the position of the trailing vehicle 26 on the defined road section 10. In a first step, a map is in this case created, as described with reference to FIG. 4. In a next step, the trailing vehicle 26 then receives potential positions (xₚₒₜ, yₚₒₜ) with corresponding accuracy coefficients KG from at least two sources 40. In a further step, these received potential positions (xₚₒₜ, yₚₒₜ) are then weighted on the basis of the accuracy coefficients K_{G} and then fused in a further step to give the position of the trailing vehicle 26. Based on the position of the trailing vehicle 26 that is thus determined, the trailing vehicle 26 may then be controlled by the controller 30.

### LIST OF REFERENCE SIGNS

10 road section
12 ego vehicle
16 transmitter
18 processing device
20 processing module
22 storage apparatus
24 sensor
26 trailing vehicle
28 receiver
30 controller
32 (partially) autonomous vehicle system
34 control unit
36 output unit
38 driver assistance system
40 source
42 infrastructure
44 control system
K_{G} accuracy coefficient
σᵢ standard deviation
(xₙ, yₙ) ego trajectory
(xᵢ, yᵢ) swarm trajectory
(xₚₒₜ, yₚₒₜ) potential position
yₙ direction of travel
y_{1,def} predefined value position in direction of travel yₙ
x_{n,1} x-value of the ego trajectory (xₙ, yₙ)

1. A computer-implemented method for assessing accuracy of a swarm trajectory position, defined by a processing device, of a swarm trajectory on a defined road section, the method comprising:
capturing a multiplicity of ego trajectory positions of ego vehicles moving on a defined road section;
generating a swarm trajectory having a multiplicity of swarm trajectory positions, wherein, at predefined swarm trajectory values, the associated swarm trajectory values are formed from the multiplicity of ego trajectory values;
forming a standard deviation for each formed swarm trajectory value of the swarm trajectory; and
storing pairs of the generated swarm trajectory positions and an associated accuracy coefficient for each swarm trajectory position, wherein the accuracy coefficients are proportional to the standard deviations formed for each swarm trajectory position.

2. The computer-implemented method as claimed in claim 1, wherein sensors of the ego vehicles moving on the defined road section capture the multiplicity of ego trajectory positions and the method further comprises transmitting, by the sensors, the multiplicity of ego trajectory positions to a processing device arranged outside the ego vehicles, and the processing device generates the swarm trajectory.

3. The computer-implemented method as claimed in claim 1, wherein sensors of the ego vehicles moving on the defined road section capture the multiplicity of ego trajectory positions, each ego vehicle generates its ego trajectory from its captured ego trajectory positions, each ego vehicle transmits its generated ego trajectory to the processing device arranged outside the ego vehicles, and the processing device generates the swarm trajectory from the ego trajectory positions.

4. A computer-implemented method for controlling a trailing vehicle on a defined road section, the method comprising:
creating a map of the defined road section containing the pairs of swarm trajectory positions and the associated accuracy coefficients for each swarm trajectory position by performing a method as claimed in claim 1; and
controlling a trailing vehicle so as to drive the road section based on the created map.

5. The computer-implemented method as claimed in claim 4, wherein the trailing vehicle is controlled using a controller of an at least partially autonomous vehicle system or wherein an output unit of a driver assistance system outputs control specifications for controlling the trailing vehicle.

6. A computer-implemented method for determining a position of a trailing vehicle on a defined road section, the method comprising:
performing a method as claimed in claim 1;
receiving, from at least two different sources, respective pairs of a potential position of the trailing vehicle on the defined road section and a source-specific accuracy coefficient associated with the potential position, wherein a first potential position is a swarm trajectory position, and wherein a first accuracy coefficient is proportional to the standard deviation, formed for the swarm trajectory position, wherein the swarm trajectory position and the first accuracy coefficient being generated by the processing device;
weighting each of the received potential positions based on the associated, source-specific accuracy coefficients; and
determining the position of the trailing vehicle by fusing the weighted potential positions.

7. The computer-implemented method as claimed in claim 6, wherein a pair of a second potential position and a source-specific accuracy coefficient associated with the second potential position is determined using a sensor assigned to the trailing vehicle or using a sensor of an infrastructure in the region of the defined road section.

8. A computer-implemented method for controlling a trailing vehicle on a defined road section, the method comprising:
determining a position of the trailing vehicle on the defined road section by performing a method as claimed in claim 4;
wherein controlling the trailing vehicle comprises controlling the trailing vehicle so as to drive on the road section based on the determined position of the trailing vehicle.

9. The computer-implemented method as claimed in claim 8, wherein the trailing vehicle is controlled using a controller of an at least partially autonomous vehicle system or wherein an output unit of a driver assistance system outputs control specifications for controlling the trailing vehicle.

10. A control system for controlling a trailing vehicle so as to drive a road section, having a processing device that is configured to perform a method as claimed in claim 1, and a controller that is configured to control the trailing vehicle by performing:
creating a map of the defined road section containing the pairs of swarm trajectory positions and the associated accuracy coefficients for each swarm trajectory position; and
controlling the trailing vehicle so as to drive on the road section based on the created map.

11. A control system for controlling a trailing vehicle so as to drive a road section, having a processing device that is configured to perform a method as claimed in claim 6, and a controller that is configured to control the trailing vehicle by performing:
creating a map of the defined road section containing the pairs of swarm trajectory positions and the associated accuracy coefficients for each swarm trajectory position:
controlling a trailing vehicle so as to drive the road section based on the created map; and
determining a position of the trailing vehicle on the defined road section;
wherein controlling the trailing vehicle comprises controlling the trailing vehicle so as to drive on the road section based on the determined position of the trailing vehicle.

12. A computer program product that is configured to carry out the method as claimed in claim 1.
